(19) United States
(12) Patent Application Publication
(10) Pub. No.: US 2008/0026747 A1
(43) Pub. Date: Jan. 31, 2008

(54) Multi-frequency radio operating in multiple layers of multi-layer network

(75) Inventors: Nelson Navarro, Freehold Township, NJ (US); Timothy S. Matt, Yardley, PA (US); Wade W. Smith, Skillman, NJ (US)

Correspondence Address: Steven H. Meyer, Esq., 213 Yale Road, Wayne, PA, 19087-2650, US

(73) Assignee: Wellspring Wireless, Inc., a DE Corporation, Bristol, PA (US)

(21) Appl. No.: 11/820,957

(22) Filed: Jun. 21, 2007

Related U.S. Application Data
(60) Provisional application No. 60/815,514, filed on Jun. 21, 2006.

(51) Int. Cl. H04Q 7/20

(52) U.S. Cl. 455/426.1

(57) ABSTRACT

A radio communications network is provided in a neighborhood of local units, and has a gateway at each local unit and a neighborhood network manager communicating data with each gateway over an upper layer of the network. Each local unit has equipment that communicates data with the gateway thereof over a lower layer of the network. Each gateway includes a radio and operates the radio according to a protocol that defines a plurality of radio channels. The gateway employs a first one of the plurality of radio channels as an upper layer channel to communicate data in the upper layer of the network, and also employs a second one of the plurality of radio channels different from the first one as a lower layer channel to communicate data in the lower layer of the network.

### CROSS REFERENCE TO RELATED APPLICATION

This application claims the benefit of U.S. Provisional application Ser. No. 60/______, filed Jun. 21, 2006 under Practitioner's Docket No. 066507-5007PR and entitled “Multi Frequency Radio Multi-Network”, hereby incorporated by reference in its entirety.

### TECHNICAL FIELD

The present invention describes a multi-layered radio network system that operates at different frequencies in different layers in order to minimize the interference between network layers. More particularly, the invention relates to such a system that operates at multiple frequencies, at least one of which is employed to communicate at a lower, intra-unit layer and at least one of which is employed to communicate at an upper, inter-unit layer.

### BACKGROUND OF THE INVENTION

In a communications network, it may at times be advantageous and/or necessary to operate in a tiered fashion in which gateways are established between layers. For example, in one communications network, it may be that at a lower layer of communications occurs within a local unit, such as an office, a house, an apartment, or the like, and that at an upper layer of communications occurs between the local units of the lower layer, or between each local unit of the lower layer and another element such as a neighborhood network manager or the like. In such a circumstance, each local unit would have a gateway that effectuates communications within the local unit (i.e., at the lower layer) and that also effectuates communications outside the local unit (i.e., at the upper layer).

Typically, the communications architecture and method employed at the lower layer is different from the communications architecture and method employed at the upper layer, and accordingly the gateway at each local unit in effect acts as a bridge between the differing communications architectures and methods. In doing so, the potential for interference between the upper and lower layers is minimized if not eliminated. However, the use of differing communications architectures and methods in different communication layers in a communications network can be expensive, cumbersome, overly difficult, and/or otherwise undesirable.

Accordingly, a need exists for a communications network with a gateway at each local unit that employs the same communications architecture and method to communicate at the lower layer and the upper layer, while still minimizing if not eliminating interference between the layers. In particular, a need exists for such a gateway that establishes separate layers by selecting different radio frequency channels for each layer of the network to operate on.

### SUMMARY OF THE INVENTION

The aforementioned needs are satisfied at least in part by the present invention in which a radio communications network is provided in a neighborhood of local units. The radio communications network has a gateway at each local unit and a neighborhood network manager communicating data with the gateway at each local unit over an upper layer of the network. Each local unit has at least one equipment node therein associated with equipment of the local unit, and each equipment node of the local unit communicates data with the gateway of such local unit over a lower layer of the network.

The gateway at each local unit includes a radio and operates the radio according to a predefined protocol that defines a plurality of radio channels. At each local unit, the gateway employs the predefined protocol and a first one of the plurality of radio channels as an upper layer channel to communicate data in the upper layer of the network. In addition, the gateway at each local unit employs the predefined protocol and a second one of the plurality of radio channels different from the first one as a lower layer channel to communicate data in the lower layer of the network.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a neighborhood of local units that each have a gateway for forming a network in accordance with one embodiment of the present invention; and

FIG. 2 is a flow diagram showing key steps performed at the gateway of FIG. 1 in the course of joining and operating in the network of FIG. 1 in accordance with one embodiment of the present invention.

### DETAILED DESCRIPTION OF THE INVENTION

Typical Environment

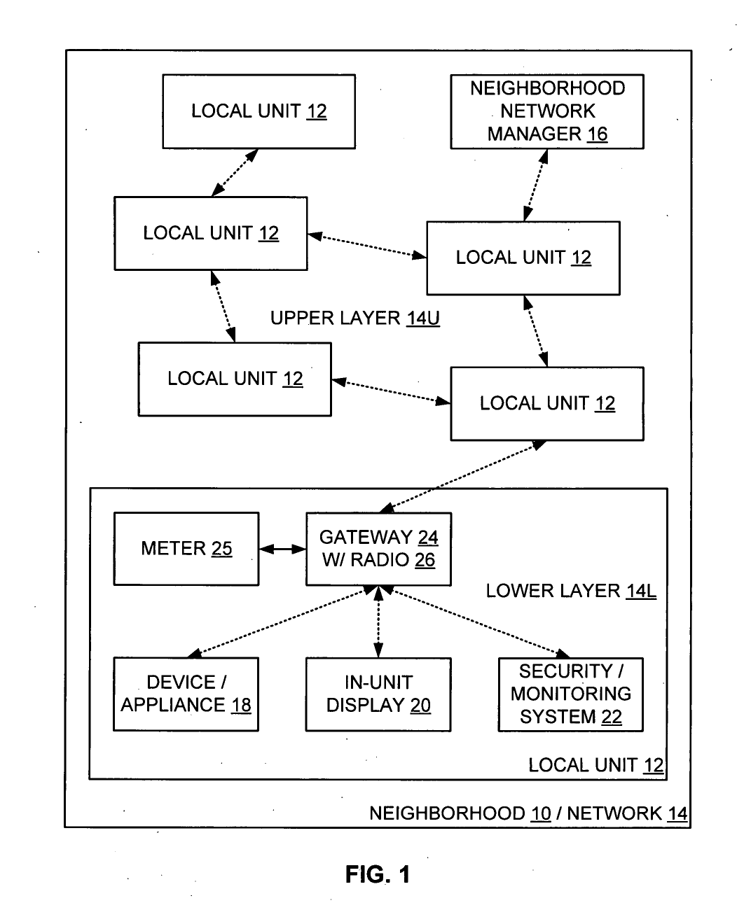

FIG. 1 and the following discussion are intended to provide a brief general description of a typical environment in which the present invention may be implemented. It should be understood, however, that the present invention may also be implemented in other similar environments without departing from the spirit and scope of the present invention.

As seen in FIG. 1, a neighborhood 10 of local units 12 are communicatively coupled by way of communications network 14 to a neighborhood network manager 16. As shown, the neighborhood 10 of local units 12 is a neighborhood of houses, apartments, offices, condominiums, cooperatives, or the like, and the neighborhood network manager 16 is or is communicatively coupled to a central agent such as for example an agent that provides utilities, including water utilities, heat utilities, gas utilities, electricity utilities, sewage utilities, cable television utilities, digital broadband access utilities, and/or the like. If the neighborhood network manager 16 is communicatively coupled to such a central agent, such coupling may be achieved by any appropriate bridging mechanism without departing from the spirit and scope of the present invention. For example, if data to and/or from the central agent is relatively intermittent or small in nature, the coupling may be by way of wire-line or wireless (cellular) telephone. Conversely, if relatively steady or large in nature, the coupling may be by way of a dedicated wire or wireless connection.

Typically, although not necessarily, the neighborhood network manager 16 collects information from each local unit 12 in the neighborhood 10 by way of the network 14, and especially information pertaining to the utilities provided by the central agent. Thus, if water is provided to the local unit 12, the collected information may include water meter readings. Similarly, the information collected by way of the network 14 may include electric meter readings, gas meter readings, energy (heating and/or cooling) meter readings and the like. As may be appreciated, such information may be employed by a particular utility not only for billing purposes but also to make decisions both locally and regionally about generating or otherwise supplying capacity, and matching available capacity to demand.

Notably, in addition to collecting information, the neighborhood network manager 16 may also provide information to the local unit 12 by way of the network 14, and may in fact even issue commands to equipment nodes within the local unit 12 by way of the network 14. Thus, and as shown in FIG. 1, an electric utility may employ the network 14 to control the electrical load of a particular device or appliance 18 within the local unit 12 by way of an appropriate node and therefore reduce electrical usage associated with such local unit. Similarly, such an electric utility or another utility may feed data to a display 20 that may be viewed by an occupant of the local unit 14 by way of an appropriate node, such as utility rates, consumption rates, cumulative use, projected use, and/or the like. Such displayed data may thus encourage the occupant to make consumption decisions with the benefit of useful information about the financial and other consequences thereof. Likewise, a security service may employ the network 14 to monitor a security/monitoring system 22 in the local unit 12 by way of an appropriate node; a local maintenance service may employ the network 14 to monitor for performance failures in the local unit 12 by way of an appropriate node, such as for example loss of heat, presence of termites, existence of a plumbing leak, maintenance status or alerts, etc.; and a data service may employ the network 14 to provide inbound information to the local unit 12 by way of an appropriate node, such as for example a current weather report, sports scores, stock market trends, etc.

Gateway 24

As was alluded to above, in a communications network 14 such as that employed in the neighborhood of FIG. 1, the architecture thereof can be described as having a lower layer 14L and an upper layer 14U. In particular, and still referring to FIG. 1, the lower layer 14L of communications occurs within each local unit 12, and the upper layer 14U of communications occurs between the local units 12 of the lower layer 14L and/or between each local unit 12 of the lower layer 14L and the neighborhood network manager 16 or the like. To effectuate the communications in both the lower layer 14L and upper layer 14U of the network 14, and as shown, each local unit 12 has a gateway 24.

As may be appreciated, such gateway 24 may be a stand-alone device or as shown in FIG. 1 may be associated with another device, such as a utility meter 25. Principally, and as should now be appreciated, the gateway 24 establishes communications and in fact effectuates communications within both the upper and lower layers 14U, 14L according to predetermined protocols. Such gateway 24 and such protocols may be any appropriate gateways and protocols without departing from the spirit and scope of the present invention.

As was alluded to above, in the prior art, a typical gateway 24 and network 14 would employ different communications protocols and standards as between the upper and lower layers 14U, 14L, whereby the gateway 24 at each local unit 12 would in effect act as a bridge between the differing protocols and standards. Thus, interference between the upper and lower layers 14U, 14L was minimized if not eliminated. However, and again, the use of differing protocols and standards is expensive, cumbersome, overly difficult, and/or otherwise undesirable. Accordingly, in one embodiment of the present invention, the gateway 24 employs the same protocols and standards in both the upper and lower layers 14U, 14L.

In one embodiment of the present invention, the gateway 24 of each local unit 12 in the neighborhood 10 employs a ZIGBEE-type two-way radio 26 that is operated according to a ZIGBEE-type protocol akin to that set forth in IEEE Standard 802.15.4 to participate in the network 14, with certain modifications as set forth below. ZIGBEE-type radios and IEEE Standard 802.15.4 are generally known or should be apparent to the relevant public and therefore need not be set forth herein in any detail other than that which is provided. Accordingly, any appropriate ZIGBEE-type two-way radio or other two-way radio may be employed with appropriate modification as necessary or desired without departing from the spirit and scope of the present invention. Moreover, although the present invention is set forth primarily in terms of a ZIGBEE-type radio 26, it should also be appreciated that any other type of two-way radio and corresponding protocol may also be employed without departing from the spirit and scope of the present invention.

As may be appreciated, ZIGBEE-type radios in particular have been used to communicate building control and monitored data according to an open published communications protocol. As may also be appreciated, ZIGBEE-type radios form a self healing two-way mesh network that delivers much higher data through-put reliability. Thus, if one node fails, another picks up the load. If messages are not acknowledged, retires occur. If frequency interference becomes an issue, the frequency of the network can be changed.

Inasmuch as a ZIGBEE-type radio 26 can receive and send data, a gateway 24 with such a ZIGBEE-type radio 26 can deliver data and accept control instructions. Thus, and as an example, a gateway 24 of a local unit 12 may receive instructions by way of the neighborhood network manager 16 to shut off or limit use of electricity to the local unit 12 or a controlled portion thereof. Thus, an empty apartment can be denied utility service, as can a non-paying customer, among other things. Similarly, an air conditioning unit of a local unit 12 can be shut down or be appropriately adjusted for some period of time during a peak electricity event, or another load may be shed under such circumstances.

Notably, a ZIGBEE-type radio 26 for a gateway 24 of a local unit 12 can be employed to communicate with most any device within the local unit 12, presuming the local unit 12 is properly equipped with facilities necessary to effectuate such communication. Thus, a ZIGBEE-type radio 26 for a gateway 24 of a local unit 12 can be employed in connection with a security/monitoring system 22 for security monitoring and other monitoring, a thermostat of a device/appliance 18 for intelligent temperature control, an electric load to control same during peak situations, an electric meter 25 to monitor usage over relatively short intervals, an intercom, a display 20 to display text messages, and many others.

Significantly, a ZIGBEE-type radio 26 receives and transmits data at a relatively low rate. Thus, and significantly, such a ZIGBEE-type radio 26 is highly energy efficient, and in fact may be expected to last at least seven years in a typical network 14 without replacing batteries.

In a network 14 of ZIGBEE-type radios 26, any one of 16 channels can be employed. As will be set forth in more detail below, then, in one embodiment of the present invention, all gateways 24 of local units 12 in a particular network 14 for a particular neighborhood 10 employ a particular channel from among four pre-selected ones of the ZIGBEE-type radio channels to communicate with each other at the upper layer 14U of the network 14. Similarly, the gateway 24 of any particular local unit 12 in the neighborhood 10 employs a particular channel from among the other twelve of the ZIGBEE-type radio channels to communicate within such local unit 12 and at the lower layer 14L of the network 14.

Similarly, in one embodiment of the present invention, each ZIGBEE-type radio 26 in a network 14 of a neighborhood 10 is allowed to transmit at power levels that can vary between 1 milliwatt (0.001 watt) and 100 mW (0.1 watt). In particular, in such embodiment, specialized software in each ZIGBEE-type radio 26 adjusts the power level thereof as the radio environment changes. Accordingly, as furniture moves, new interference sources arise, trees grow, and weather occurs, transmit power is adjusted automatically to assure that proper data transmission is achieved while minimizing the interference footprint of each transmission.

Notably, while ZIGBEE-type radios 26 have heretofore been employed within a local unit 12 and at the lower layer 14L of a network 14, such radios have not likewise also been employed at the upper layer 14U of the network 14. In particular, such a ZIGBEE-type radio has not heretofore been employed in a layered network 14 with more than one network layer separated by frequency channel. In the present invention, then, a ZIGBEE-type radio 26 at the gateway 24 of each local unit functions in two layers, acting as a gateway or coordinator in the lower layer 14L of network 14 and as a router and data end point node in the upper layer 14U of such network 14. However, and as may be appreciated, to do so, each ZIGBEE-type radio 26 must be employed with additional operating parameters on top of the aforementioned ZIGBEE/IEEE protocol in order to assure that data can be transferred without bridging to some other communications protocol at the interface of the upper and lower layers 14U, 14L.

Method Employed by Gateway 24

In one embodiment of the present invention, the gateway 24 at each local unit 12 employs a single type radio 26 to communicate both at the lower layer 14L (i.e., at the local unit 12) and at the upper layer 14U (i.e., with other ZIGBEE-type radios 26 and/or the neighborhood network manager 16), where communication within the local unit 12 does not interfere with communication within other local units 12 by way of other ZIGBEE-type radios 26 in the network 14 of the neighborhood 10, and also where communication at the lower layer 14L of the network 14 by way of the ZIGBEE-type radio 26 associated with such gateway 24 does not interfere with communication at the upper layer 14U of the network 14 by way o such ZIGBEE-type radio 26.

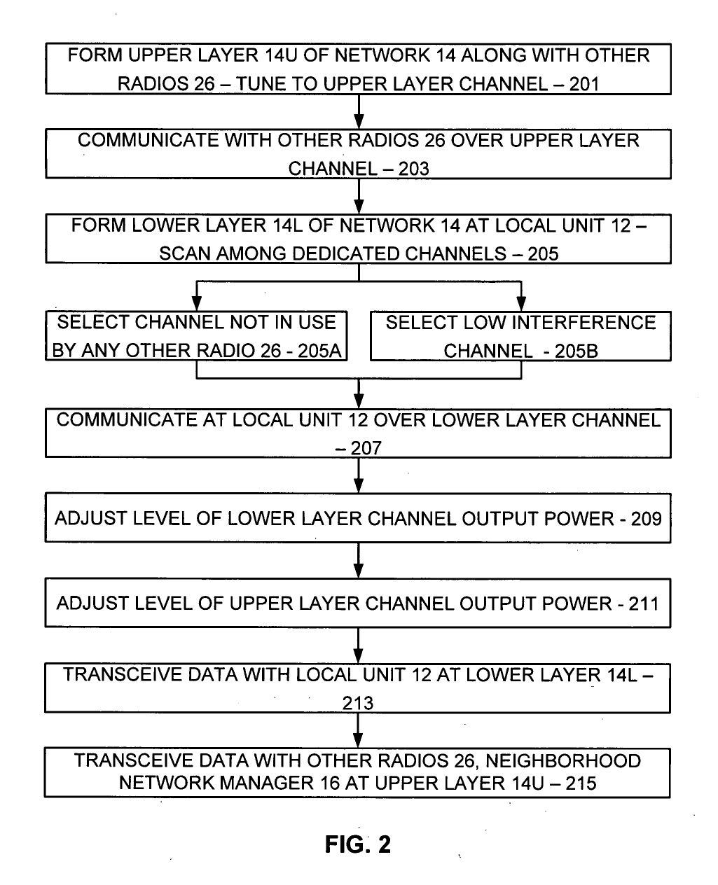

In particular, and turning now to FIG. 2, in one embodiment of the present invention, the ZIGBEE-type radio 26 at each gateway 24 employs the following steps to establish communications, both at the upper layer 14U and the lower layer 14L of the network 14 within which such gateway 24 participates. Preliminarily, the ZIGBEE-type radio 26 of the gateway 24 (hereinafter, ‘radio 26′’) forms the upper layer 14U of the network 14 along with the other radios 26 (step 201). Such formation of the upper layer 14U of the network 14 may be achieved in any appropriate manner without departing from the spirit and scope of the present invention. For example, assuming that each radio 26 operates on any of sixteen channels/frequencies (hereinafter, ‘channels’) it may be that all of the radios 26 receive an appropriate command or acknowledgment from the neighborhood network manager 16 to tune to a particular one of the channels from among four pre-determined channels. Such a command identifying an upper layer channel may be issued or acknowledged in any appropriate manner without departing from the spirit and scope of the present invention. Of course, once the upper layer channel command or acknowledgment has been received by each radio 26, the radios 26 may communicate with each other over the upper layer channel as necessary to establish relationships and transmit data therebetween (step 203).

Once the upper layer 14U of the network has been formed as at step 201, the radio 26 at each local unit 12 forms the lower layer 14L of the network 14 at such local unit 12 (step 205). Similar to before, such formation of the lower layer 14L of the network 14 may be achieved in any appropriate manner without departing from the spirit and scope of the present invention. In one embodiment of the present invention, and again assuming that each radio 26 operates on any of sixteen channels, the radio 26 forms the lower layer 14L at the local unit 12 thereof by scanning among the twelve remaining channels and selecting a particular channel that does not appear to be in use by any other radio 26 (step 205a).

Alternatively, if all channels appear to be in use, the radio 26 selects a channel with a relatively low potential for interference from other radios 26 in the network 14 (step 205b), where such selection may be determined at least in part based on relative signal strength of the perceived interference. As before, once the lower layer channel has been selected by the radio 26, such radio 26 may communicate with items 18, 20, 22, etc. at the local unit 12 of the radio 26 in a known manner and as necessary to establish relationships and transmit data therebetween (step 207). Notably, whether selected at step 205a or 205b, the lower layer channel is of course a different channel than the upper layer channel. Thus, interference between such upper and lower layers 14U, 14L at the radio 26 should be minimized if not eliminated based on the use of such differing channels for each such layer.

During operation of the radio 26, the output power thereof when transmitting over the lower layer channel should be no greater than is required to communicate with the items 18, 20, 22, etc. at the local unit 12 of such radio 26. Accordingly, and in one embodiment of the present invention, the level of such lower layer channel output power is adjusted as is necessary (step 209). Such adjustment may occur both when the lower layer channel is selected as at step 205 and at future times. Similarly, the output power of the radio 26 when transmitting over the upper layer channel should be no greater than is required to communicate with other radios 26 in the network. Accordingly, and in one embodiment of the present invention, the level of such upper layer channel output power is also adjusted as is necessary (step 211). Each such adjustment may occur both when the respective layer channel is selected as at steps 201 and 205 and at future times.

Each such adjustment may be performed in any appropriate manner without departing from the spirit and scope of the present invention. For example, such adjustment may be achieved by decreasing output power based on received signal strength and increasing such output power with each successive communications failure. Accordingly, the level of the lower layer channel output power is arrived at when the power at which all items 18, 20, 22, etc. are responsive has been determined. Similarly, the level of the upper layer channel output power is arrived at when the power at which at least one other radio 26 or the neighborhood network manager 16 is responsive has been determined. Thereafter, the radio 26 employs the arrived-at power level until any other communications failure occurs, in which case the power level may be increased. Note that the lower and upper layer power levels may and likely do differ, perhaps substantially.

In operation, then, each radio 26 by way of the selected lower layer channel thereof monitors the local unit 12 thereof and transceives data therewith as necessary and/or desired to effectuate the lower layer 14L of the network 14 at the local unit 12 (step 213). Thus, it may be the case that the radio 26 reads an electric meter 25 or other meter 25 at the local unit 12 and transmits same to the display 20 of the local unit 12, perhaps every 10 seconds or so. Note here that such transmitted data is on the order of 4 bytes or so, and thus requires very little power consumption. Of course, the radio 26 of the gateway 24 may perform other data reception and transmission tasks at the lower layer 14L and thus at the local unit 12 without departing from the spirit and scope of the present invention, including tasks regarding devices/appliances 18 and security/monitoring system 22, among others.

In a similar manner, each radio 26 by way of the selected upper layer channel thereof interacts with other radios 26 and/or the neighborhood network manager 16 and transceives data therewith as necessary and/or desired to effectuate the upper layer 14U of the network 14 at the local unit 12 (step 215). Thus, it may be the case that the radio 26 reads an electric meter 25 or other meter 25 at the local unit 12 and transmits same to the neighborhood network manager 16, perhaps every 15 minutes or so. Alternatively, the gateway 24 may archive multiple readings and employ the radio 26 to transmit a batch thereof to the neighborhood network manager 16 at some point. Again, each such reading of such transmitted data is on the order of 4 bytes or so, and thus requires very little power consumption. Of course, the radio 26 of the gateway 24 may perform other data reception and transmission tasks at the upper layer 14U without departing from the spirit and scope of the present invention, including tasks requested by the neighborhood network manager 14 and tasks initiated by the gateway 24, among others.

If the neighborhood network manager 16 receives updated meter readings every 15 minutes or so, as was set forth above, it may be appreciated, that such received meter readings can be archived at the neighborhood network manager 16 and/or at a higher level. Such received meter readings may of course be employed to bill a customer at the corresponding local unit 12 for service as provided, and may also be employed to monitor for current load levels and the like. For example, if received every 15 minutes, each reading can be archived, and an immediately prior 15 minute read may be subtracted from a current reading to result in an interval reading that can be logged by the neighborhood network manager 16 with a time stamp. Alternatively, the gateway 24 may calculate such interval reading and time stamping and transmit same to the neighborhood network manager 16 by way of the radio 26 in some batch form.

As was alluded to above, the neighborhood network manager 16 may also employ the radio 26 and gateway 24 of each local unit in the network 14 to transmit broadcast messages and the like thereto. Such messages may be common to all local units 12 or unique to each local unit 12, and may for example be text and the like to be displayed at the display 20 of each local unit 12. For example, such messages may include information on current or time-of-day utility rates, helpful messages such as weather reports or other useful information formatted to be compatible with the display 20. Upon initially receiving such a message for such display 20, and especially if the message may take some time to receive and be relayed to the display 20, it may be that the corresponding gateway 24 suspends its higher frequency current activities until such relaying is concluded. For example, the aforementioned reading a meter 25 every 10 seconds may be suspended to allow all such a message to transfer without interference risk caused by the larger data packets.

### CONCLUSION

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the present invention, a system and method are provided to effectuate a communications network with a gateway 24 at each local unit 12 that employs the same communications architecture and method to communicate at the lower layer 14L and the upper layer 14U of a network 14, while still minimizing if not eliminating interference between the layers. The gateway 24 employs a ZIGBEE-type radio 26 or the like, and establishes separate layers by selecting different ZIGBEE-type channels for each layer of the network 14 to operate on.

It should be appreciated that changes could be made to the embodiments described above without departing from the inventive concepts thereof. It should be understood, therefore, that this invention is not limited to the particular embodiments disclosed, but it is intended to cover modifications within the spirit and scope of the present invention as defined by the appended claims.

1. A radio communications network in a neighborhood of local units, the radio communications network comprising a gateway at each local unit and a neighborhood network manager communicating data with the gateway at each local unit over an upper layer of the network, each local unit having at least one equipment node therein associated with equipment of the local unit, each equipment node of the local unit communicating data with the gateway of such local unit over a lower layer of the network, the gateway at each local unit including a radio and operating the radio according to a predefined protocol that defines a plurality of radio channels, the gateway at each local unit employing the predefined protocol and a first one of the plurality of radio channels as an upper layer channel to communicate data in the upper layer of the network and employing the predefined protocol and a second one of the plurality of radio channels different from the first one as a lower layer channel to communicate data in the lower layer of the network.

2. The network of claim 1 wherein each local unit in the neighborhood is one of a house, an apartment, an office, a condominium, and a cooperative.

3. The network of claim 1 wherein the neighborhood network manager is communicatively coupled to a central agent, wherein the central agent provides utilities to each local unit in the neighborhood including at least one of water utilities, heat utilities, gas utilities, electricity utilities, sewage utilities, cable television utilities, and digital broadband access utilities, wherein the neighborhood network manager collects information from each local unit in the neighborhood by way of the network, the collected information pertaining to the utilities provided by the central agent, and wherein the neighborhood network manager also provides information to each local unit by way of the network, the provided information also pertaining to the utilities provided by the central agent and including at least one of commands to the equipment of the local unit and data to be displayed at a display of the local unit.

4. The network of claim 1 wherein the radio of each gateway is a ZIGBEE-type radio and wherein the predefined protocol is based on a ZIGBEE-type protocol.

5. The network of claim 1 wherein, for all of the gateways, the upper layer channel thereof is assigned to the gateways from among a plurality of channels reserved for the upper layer of the network, and wherein, for each gateway, the lower layer channel thereof is selected by the gateway from other channels not reserved for the upper layer of the network.

6. The network of claim 1 wherein, for all of the gateways, the upper layer channel thereof is a single channel commonly assigned to all of the gateways, the single channel being selected from among a plurality of channels reserved for the upper layer of the network, and wherein, for each gateway, the lower layer channel thereof is selected by the gateway from other channels not reserved for the upper layer of the network.

7. The network of claim 1 wherein each gateway for each of the upper and lower layer channels thereof adjusts the transmission power of the radio thereof over the channel as environmental conditions change to assure that proper transmission is achieved while minimizing power use, the transmission power as adjusted for the upper layer channel of the gateway at least potentially differing from the transmission power as adjusted for the lower layer channel of such gateway.

8. The network of claim 1 wherein each gateway acts as a network coordinator for the lower layer and also as a router node in the upper layer.

9. In a radio communications network in a neighborhood of local units, a gateway at each local unit, the gateway of each local unit communicating data with a neighborhood network manager over an upper layer of the network, the local unit having at least one equipment node therein associated with equipment of the local unit, each equipment node of the local unit communicating data with the gateway of such local unit over a lower layer of the network, the gateway at each local unit including a radio and operating the radio according to a predefined protocol that defines a plurality of radio channels, the gateway at each local unit employing the predefined protocol and a first one of the plurality of radio channels as an upper layer channel to communicate data in the upper layer of the network and employing the predefined protocol and a second one of the plurality of radio channels different from the first one as a lower layer channel to communicate data in the lower layer of the network.

10. The gateway of claim 9 wherein each local unit in the neighborhood is one of a house, an apartment, an office, a condominium, and a cooperative.

11. The gateway of claim 9 wherein the neighborhood network manager is communicatively coupled to a central agent, wherein the central agent provides utilities to the local unit of the gateway including at least one of water utilities, heat utilities, gas utilities, electricity utilities, sewage utilities, cable television utilities, and digital broadband access utilities, wherein the neighborhood network manager collects information from the local unit of the gateway by way of the network, the collected information pertaining to the utilities provided by the central agent, and wherein the neighborhood network manager also provides information to the local unit of the gateway by way of the network, the provided information also pertaining to the utilities provided by the central agent and including at least one of commands to the equipment of the local unit and data to be displayed at a display of the local unit.

12. The gateway of claim 9 wherein the radio thereof is a ZIGBEE-type radio and wherein the predefined protocol is based on a ZIGBEE-type protocol.

13. The gateway of claim 9 wherein the upper layer channel thereof is assigned thereto from among a plurality of channels reserved for the upper layer of the network, and wherein the lower layer channel thereof is selected by the gateway from other channels not reserved for the upper layer of the network.

14. The gateway of claim 9 wherein the gateway for each of the upper and lower layer channels thereof adjusts the transmission power of the radio thereof over the channel as environmental conditions change to assure that proper transmission is achieved while minimizing power use, the transmission power as adjusted for the upper layer channel of the gateway at least potentially differing from the transmission power as adjusted for the lower layer channel of such gateway.

15. The gateway of claim 9 acting as a network coordinator for the lower layer and also as a router node in the upper layer.

16. In a radio communications network in a neighborhood of local units, a method employed by a gateway at each local unit, the gateway of each local unit communicating data with a neighborhood network manager over an upper layer of the network, the local unit having at least one equipment node therein associated with equipment of the local unit, each equipment node of the local unit communicating data with the gateway of such local unit over a lower layer of the network, the gateway at each local unit including a radio and operating the radio according to a predefined protocol that defines a plurality of radio channels, the method comprising the gateway at each local unit:
employing the predefined protocol and a first one of the plurality of radio channels as an upper layer channel;
communicating data with the neighborhood network manager in the upper layer of the network and over the upper layer channel;
employing the predefined protocol and a second one of the plurality of radio channels different from the first one as a lower layer channel; and
communicating data with each equipment node of the local unit in the lower layer of the network and over the lower layer channel.

17. The method of claim 16 wherein each local unit in the neighborhood is one of a house, an apartment, an office, a condominium, and a cooperative.

18. The method of claim 16 wherein the neighborhood network manager is communicatively coupled to a central agent, the central agent providing utilities to the local unit of the gateway including at least one of water utilities, heat utilities, gas utilities, electricity utilities, sewage utilities, cable television utilities, and digital broadband access utilities, the method comprising:
the neighborhood network manager collecting information from the local unit of the gateway by way of the network, the collected information pertaining to the utilities provided by the central agent; and
the neighborhood network manager also providing information to the local unit of the gateway by way of the network, the provided information also pertaining to the utilities provided by the central agent and including at least one of commands to the equipment of the local unit and data to be displayed at a display of the local unit.

19. The method of claim 16 wherein the radio thereof is a ZIGBEE-type radio and wherein the predefined protocol is based on a ZIGBEE-type protocol.

20. The method of claim 16 comprising:
the gateway being assigned the upper layer channel thereof from among a plurality of channels reserved for the upper layer of the network; and
the gateway selecting the lower layer channel thereof from other channels not reserved for the upper layer of the network.

21. The method of claim 16 further comprising the gateway for each of the upper and lower layer channels thereof adjusting the transmission power of the radio thereof over the channel as environmental conditions change to assure that proper transmission is achieved while minimizing power use, the transmission power as adjusted for the upper layer channel of the gateway at least potentially differing from the transmission power as adjusted for the lower layer channel of such gateway.

22. The method of claim 16 comprising the gateway acting as a network coordinator for the lower layer and also as a router node in the upper layer.
